(19) United States
(12) Patent Application Publication
(10) Pub. No.: US 2012/0192429 A1
(43) Pub. Date: Aug. 2, 2012

(54) SHAVING RAZOR WITH SERRATED-EDGE BLADES

(76) Inventor: Pasquale Savarese, Smithtown, NY (US)

(21) Appl. No.: 13/362,451

(22) Filed: Jan. 31, 2012

Related U.S. Application Data
(60) Provisional application No. 61/438,448, filed on Feb. 1, 2011.

(51) Int. Cl. B26B 21/40; A45D 27/29

(52) U.S. Cl. 30/41

(57) ABSTRACT

A shaving razor is presented including a shaving razor head and a handle. The shaving razor head includes at least two lubricated strips extending across a length of the shaving razor head; a serrated-edge blade positioned between the at least two lubricated strips; and two side guards for holding the at least two lubricated strips and the serrated-edge blade in place. The handle is connected to the shaving razor head such that the shaving razor head with the serrated-edge blade moves in accordance with movement of the handle. The serrated-edge blade employs a semi-circular concave down pattern.

### CROSS-REFERENCE TO RELATED APPLICATIONS

The present application claims priority from U.S. Provisional Patent Application No. 61/438,448 filed Feb. 1, 2011, the contents of which are incorporated herein by reference.

### BACKGROUND

1. Technical Field

The present disclosure relates to a razor with serrated-edge blades including a lubricant for a cleaner, smoother, and more efficient shaving experience.

2. Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Therefore, unless otherwise indicated herein, what is described in this section is not prior art to the description and claims in this application and is not admitted to be prior art by inclusion in this section.

Shaving razors have long been used by men. Regardless of skin conditions of men, straight linear razor blades have been dominant in the shaving razor markets. In the beginning, sharpness was a main issue with the blades. As such, a plurality of straight linear blades were included in one shaving razor for the purpose of providing more comfort, easiness, and clean cuts than a razor with one blade. Additionally, shaving razors for women have been introduced in the marketplace. In the consideration of women and men with sensitive skin and people who want easier, cleaner, and smoother shaving experiences, the number of blades on a single razor has increased to 5 blades over the years.

However, straight linear blades have a limited length of contact with the skin for cutting hair. Application of a plurality of blades increases the contact surface to cut hair. Due to the limited space in a razor head, the number of blades in the razor head is limited to a certain number. Thus, contact length of a razor for cutting hair is limited to the size of the razor head.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides for a shaving razor head. The shaving razor head includes at least two lubricated strips extending across a length of the shaving razor head; a serrated-edge blade positioned between the at least two lubricated strips; and two side guards for holding the at least two lubricated strips and the serrated-edge blade in place.

In one exemplary embodiment, the serrated-edge blade employs a semi-circular concave down pattern.

In another exemplary embodiment, the serrated-edge blade includes two blades in parallel to each other and extending the length of the shaving razor head and wherein the serrated-edge blades face the same direction with each other. Alternatively, the serrated-edge blade includes three blades in parallel to each other and extending the length of the shaving razor head and wherein the serrated-edge blades face the same direction with each other. Alternatively, the serrated-edge blade includes two blades in parallel to each other and extending the length of the shaving razor head and wherein the serrated-edge blades face the same direction with each other.

In another exemplary embodiment, the serrated-edge blade includes two blades such that serrated edges of the first blade face serrated edges of the second blade in opposed relation to each other. In yet another exemplary embodiment, the serrated-edge blade includes four blades such that serrated edges of two blades face serrated edges of the other two blades in opposed relation to each other.

The present disclosure also provides for a shaving razor, including a shaving razor head having at least two lubricated strips extending across a length of the shaving razor head; a serrated-edge blade positioned between the at least two lubricated strips; and two side guards for holding the at least two lubricated strips and the serrated-edge blade in place; and a handle connected to the shaving razor head such that the shaving razor head with the serrated-edge blade moves in accordance with movement of the handle.

The present disclosure also provides for a shaving razor, a shaving razor head having at least two lubricated strips extending across a length of the shaving razor head; a serrated-edge blade positioned between the at least two lubricated strips; and two side guards for holding the at least two lubricated strips and the serrated-edge blade in place; a handle connected to the shaving razor head such that the shaving razor head with the serrated-edge blade moves in accordance with movement of the handle; and a stand base for holding one end of the handle, such that the handle is substantially perpendicular to the stand base.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

These and other advantages will become more apparent from the following detailed description of the various embodiments of the present disclosure with reference to the drawings wherein:

FIG. 1 is a perspective view of a razor having bi-directionally disposed serrated-edge blades, a handle and a base stand, in accordance with an embodiment of the present disclosure;

FIG. 2 is front view of the razor in FIG. 1, in accordance with the embodiment of the present disclosure;

FIG. 3 is a side view of the razor in FIG. 1, in accordance with the embodiment of the present disclosure;

FIG. 4 is a top view of the razor in FIG. 1, in accordance with the embodiment of the present disclosure;

FIG. 5 is a close-up view of the razor head of the razor in FIG. 1, in accordance with the embodiment of the present disclosure;

FIG. 6 is a perspective view of a razor having 4 mono-directionally disposed serrated-edge blades, a handle and a base stand, in accordance with another embodiment of the present disclosure;

FIG. 7 is front view of the razor in FIG. 6, in accordance with the embodiment of the present disclosure;

FIG. 8 is a side view of the razor in FIG. 6, in accordance with the embodiment of the present disclosure;

FIG. 9 is a top view of the razor in FIG. 6, in accordance with the embodiment of the present disclosure;

FIG. 10 is a perspective view of a razor having 3 mono-directionally disposed serrated-edge blades, a handle and a base stand, in accordance with an embodiment of the present disclosure;

FIG. 11 is front view of the razor in FIG. 10, in accordance with the embodiment of the present disclosure;

FIG. 12 is a perspective view of a razor having 2 mono-directionally disposed serrated-edge blades, a handle and a base stand, in accordance with an embodiment of the present disclosure;

FIG. 13 is front view of the razor in FIG. 12, in accordance with the embodiment of the present disclosure;

FIG. 14 is a perspective view of a razor having 1 mono-directionally disposed serrated-edge blade, a handle and a base stand, in accordance with an embodiment of the present disclosure;

FIG. 15 is front view of the razor in FIG. 14, in accordance with the embodiment of the present disclosure;

FIG. 16 is a perspective view of a razor having bi-directionally disposed serrated-edge blades and a handle attached thereto, in accordance with the embodiment of the present disclosure;

FIG. 17 is front view of the razor in FIG. 16, in accordance with the embodiment of the present disclosure;

FIG. 18 is a side view of the razor in FIG. 16, in accordance with the embodiment of the present disclosure;

FIG. 19 is a top view of the razor in FIG. 16, in accordance with the embodiment of the present disclosure;

FIG. 20 is a perspective view of a razor having 4 mono-directionally disposed serrated-edge blades and a handle attached thereto, in accordance with an embodiment of the present disclosure;

FIG. 21 is front view of the razor in FIG. 20, in accordance with the embodiment of the present disclosure;

FIG. 22 is a side view of the razor in FIG. 20, in accordance with the embodiment of the present disclosure;

FIG. 23 is a top view of the razor in FIG. 20, in accordance with the embodiment of the present disclosure;

FIG. 24 is a perspective view of a razor having 3 mono-directionally disposed serrated-edge blades and a handle attached thereto, in accordance with an embodiment of the present disclosure;

FIG. 25 is front view of the razor in FIG. 24, in accordance with the embodiment of the present disclosure;

FIG. 26 is a perspective view of a razor having 2 mono-directionally disposed serrated-edge blades and a handle attached thereto, in accordance with an embodiment of the present disclosure;

FIG. 27 is front view of the razor in FIG. 26, in accordance with the embodiment of the present disclosure;

FIG. 28 is a perspective view of a razor having 1 mono-directionally disposed serrated-edge blade and a handle attached thereto, in accordance with an embodiment of the present disclosure; and

FIG. 29 is front view of the razor in FIG. 28, in accordance with the embodiment of the present disclosure.

The figures depict preferred embodiments of the present disclosure for purposes of illustration only. One skilled in the art will readily recognize from the following discussion that alternative embodiments of the structures and methods illustrated herein may be employed without departing from the principles of the present disclosure described herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

According to the exemplary embodiments of the present disclosure, increasing the contact length of the blades within a razor head makes the shaving experience easier, smoother and cleaner. Serration of blades presents one way of increasing a contact length in a limited linear length of the blades. Hence, reduction of forces for shaving and easiness and smoothness of shaving are further accomplished by employment of serrated-edge blades in the present disclosure.

In particular, the present disclosure employs a serrated-edge blade in a razor. The serrated-edge blade increases the perimeter of the blade that touches skin and cuts hair. The increased portion of the contact length by employing serration results in lesser forces to cut the same amount of hair, a smoother slide, and a cleaner cut than with a straight linear blade razor.

Embodiments of the presently disclosed serrated-edge blade razors will now be described in detail with reference to the drawings in which like reference numerals designate identical or corresponding elements in each of the several views.

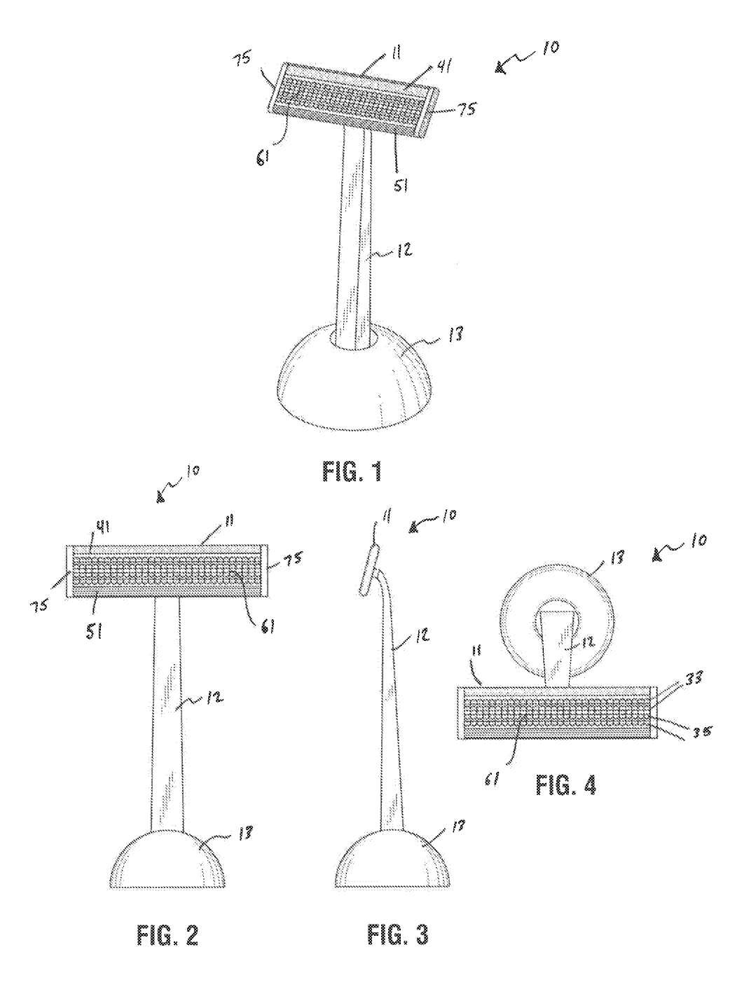

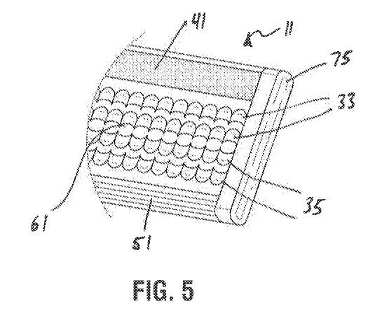

The present disclosure relates to a razor for a daily shaving routine. A shaving razor 10 with serrated-edge blades 61 is presented in FIGS. 1-4, where the razor 10 includes a head 11, a handle 12, and a base stand 13. A close-up view of the razor head 11 is shown in the FIG. 5. In FIGS. 1-5, four serrated-edge blades 61 are disposed within two lubricated strips 41, 51.

In order to make shaving smoother, the two lubricated strips 41, 51 are located on the top and the bottom segments of the razor head 11. The two lubricated strips 41, 51 secrete lubrication so that the razor head 11 moves smoothly over the skin and the lubrication protects the skin. Two side guards 75 keep the two lubricated strips 41, 51 and the serrated-edge blades 61 tight in the razor head 11 with serrated-edge blades 61.

As shown in FIGS. 1-4, the serrated-edge blades 61 are bi-directionally disposed serrated-edge blades that makes it possible for a user to shave in either direction without lifting the razor 10 from the skin and rotating the razor 10 with serrated-edge blades 61. Thus, a user may shave from left to right or right to left (or any other directions) without lifting the razor from the skin.

In one embodiment, the serrated-edge blades 61 include two blades such that serrated edges of the first blade face serrated edges of the second blade in opposed relation to each other. In another exemplary embodiment, the serrated-edge blades 61 include four blades such that serrated edges of two blades 33 face serrated edges of the other two blades 35 in opposed relation to each other (see FIGS. 4 and 5).

Stated differently, at least one row of serrated edges may extend on a top portion of the razor head 11, whereas at least one row of serrated edges may extend on a bottom portion of the razor head 11. The rows of serrated edges may extend from one side guard 75 to the other side guard 75 in a continuous or non-continuous manner. The rows of serrated edges may extend across a portion or portions of the razor head 11 without touching the side guards 75. In other words, the rows of serrated blades may be parallel to each other such that the semi-circular concave down patterns face opposite directions with respect to each other on the razor head 11. It is also contemplated that alternate rows of serrated blades may include semi-circular concave down patterns in opposed directions.

As shown in FIGS. 1-4, a base stand 13 aids in the free standing of the shaving razor 10 with serrated-edge blades 61 and, thus, takes less space in any medicine cabinet on a sink or bathroom shelf than standard razors. The base stand 13 has a wider bottom portion than top portion so that it stands on a flat surface without exterior support. It also has an opening from the top to the bottom vertically, which fits to hold a razor handle in a way that the razor does not fall aside.

As shown in FIGS. 1-4, the serrated-edge blades 61 are of a semi-circular concave down pattern, where its crests are spiky points and its troughs are circular round parts. However, the exemplary embodiments of the present disclosure are not limited to such a pattern.

Additionally, in order to describe how much a blade increases a contact perimeter by employing a semi-circular concave down pattern, simple mathematics may be applied. The circumference of a circle is 3.14 times the diameter. Hence, an employment of a half circle pattern on a blade increases the perimeter to 1.57 times the length of the blade, resulting in a 57% increase. This increase in the blade contributes to easiness and comfort in shaving to the extent of such increase. The amount of increase with different patterns depends on the patterns employed.

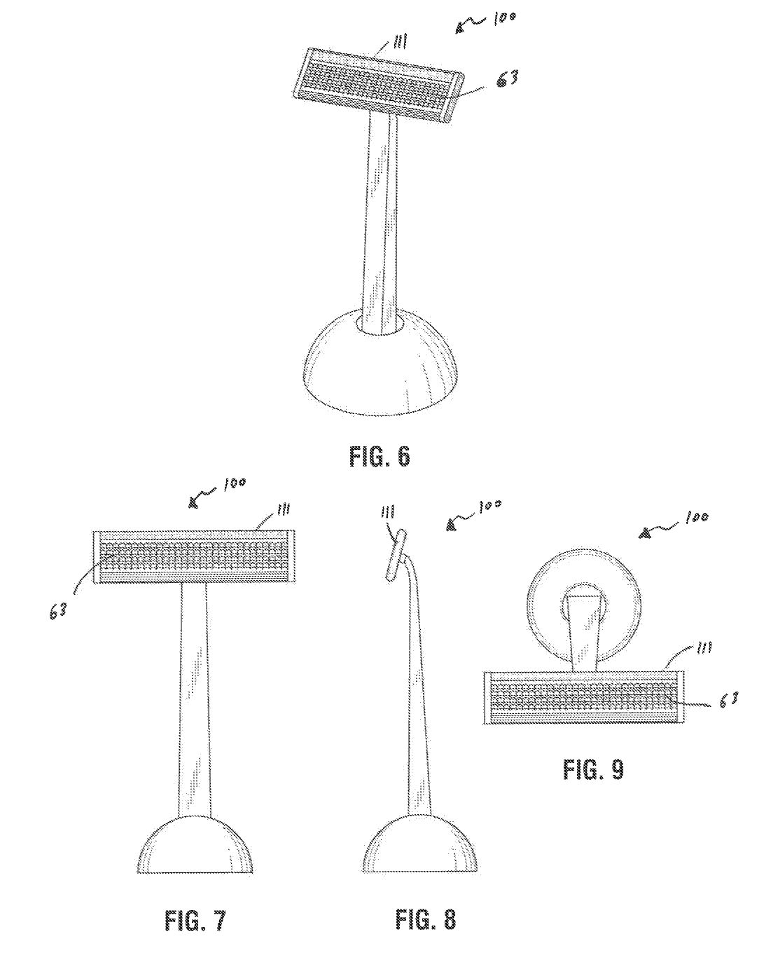

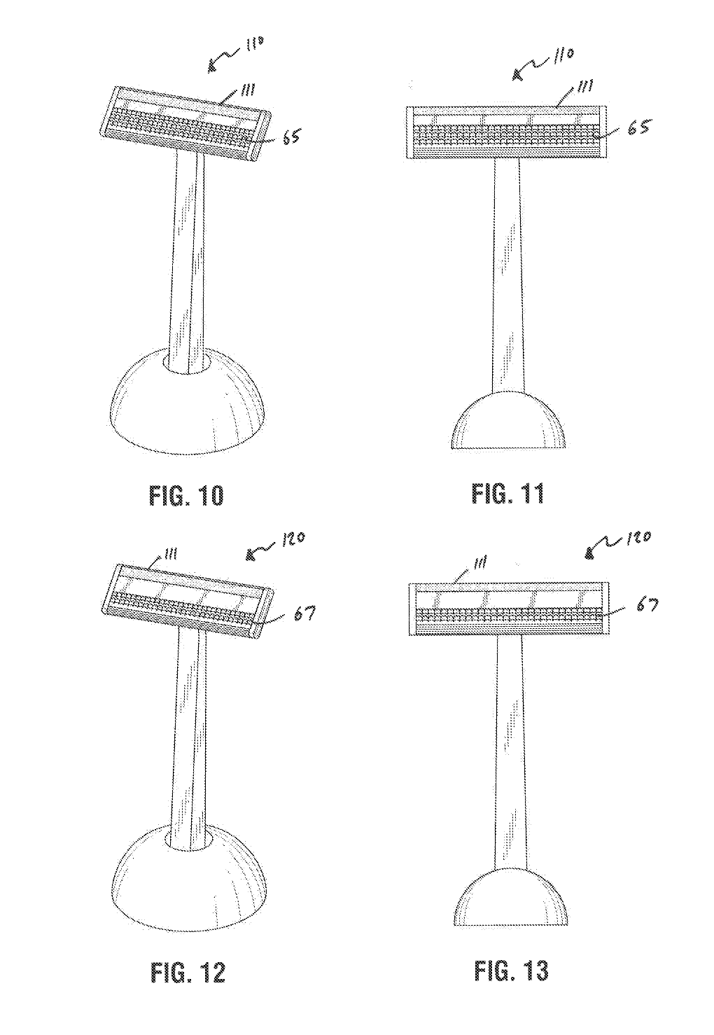

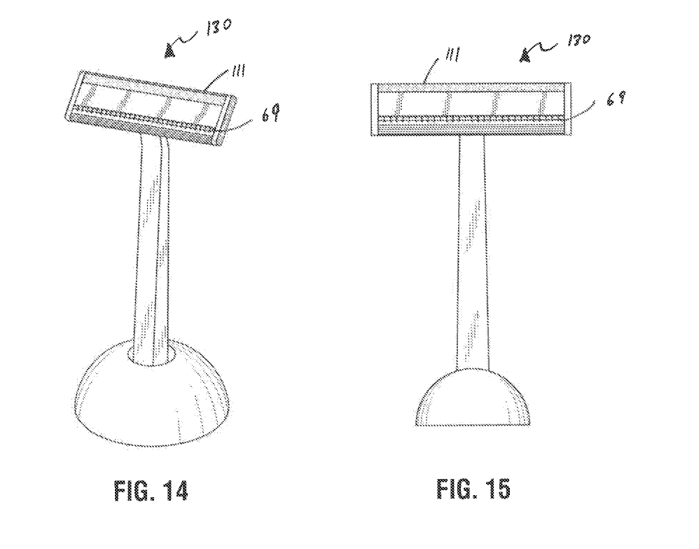

In FIGS. 6-9, the serrated-edge blades 63 of the razor 100 are mono-directionally disposed with four serrated-edge blades in parallel to each other. FIGS. 10-11 illustrate a razor 110 with three serrated-edge blades 65 in parallel to each other. FIGS. 12-13 illustrate a razor 120 with two serrated-edge blades 67 in parallel to each other. FIGS. 14-15 illustrate a razor 130 with one serrated-edge blade 69. The number of serrated-edge blades is not limited to four or three or two or one, and the limitation of the size of a razor head governs the maximum number of serrated-edge blades. Thus, in FIGS. 6-13, the rows of serrated blades may be parallel to each other such that the semi-circular concave down patterns all face the same direction with respect to the razor head 111.

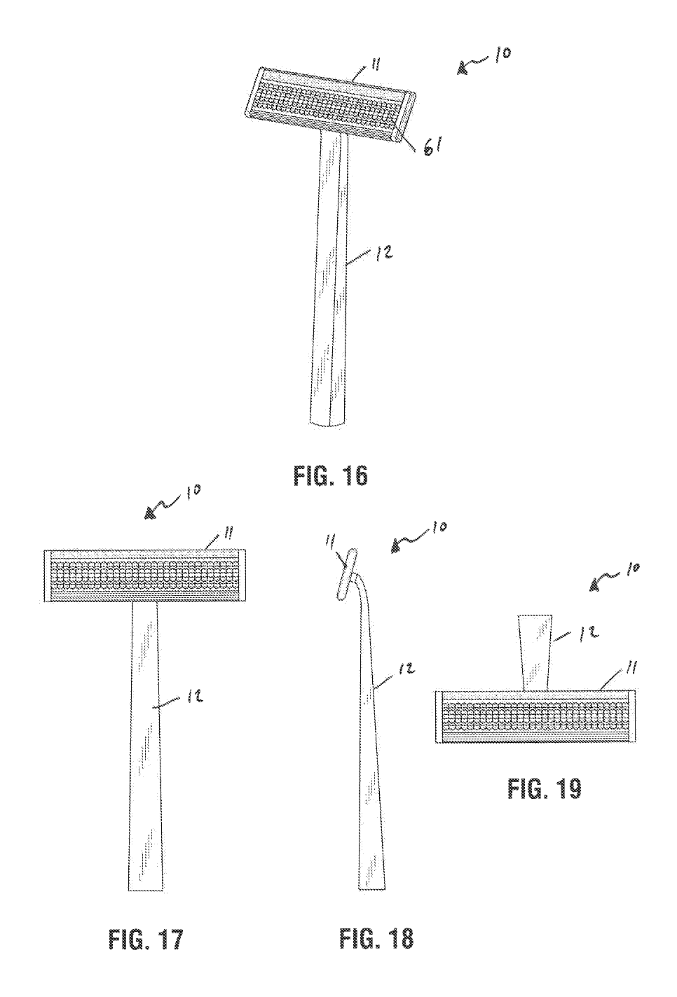

FIGS. 16-19 illustrate the razor 10 without a base stand 13 and are representations of razor 10 with the bi-directionally disposed serrated-edge blades 61 in opposed directions.

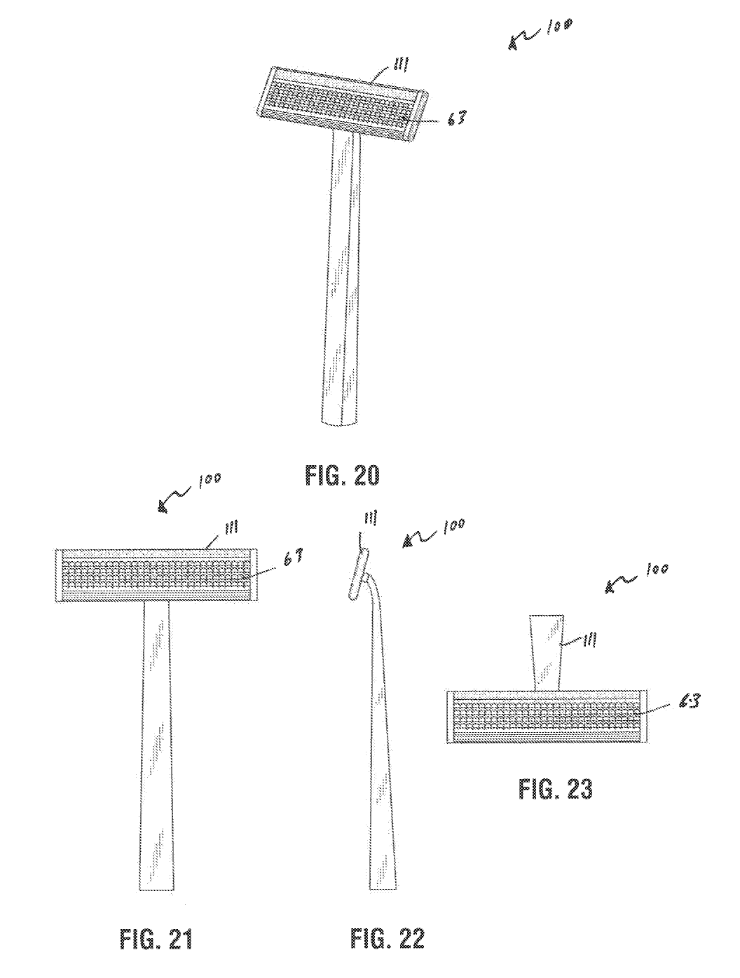

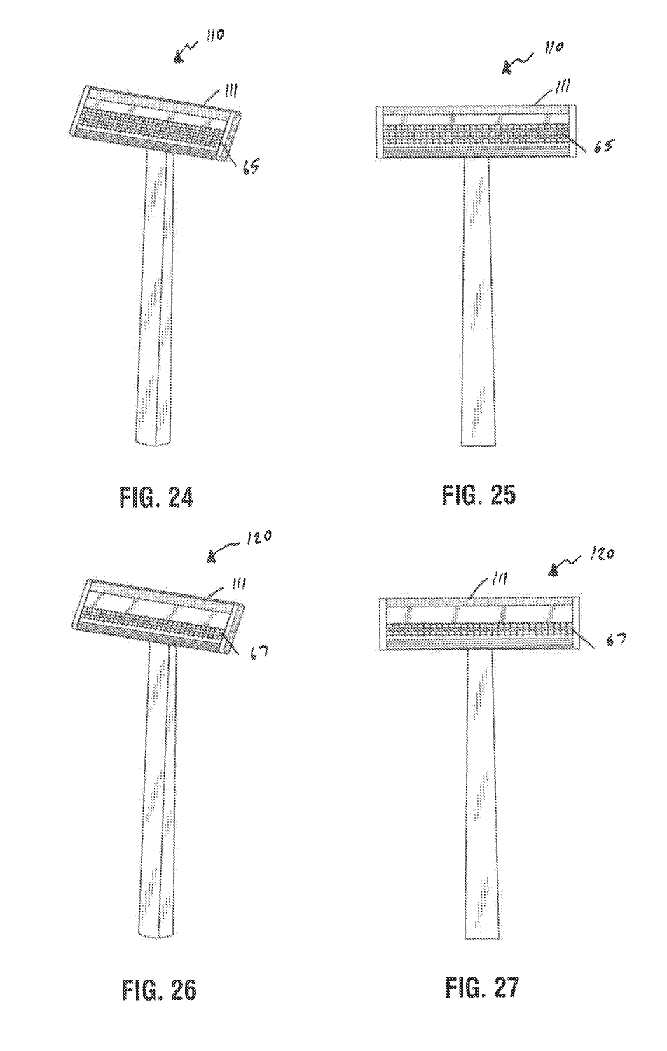

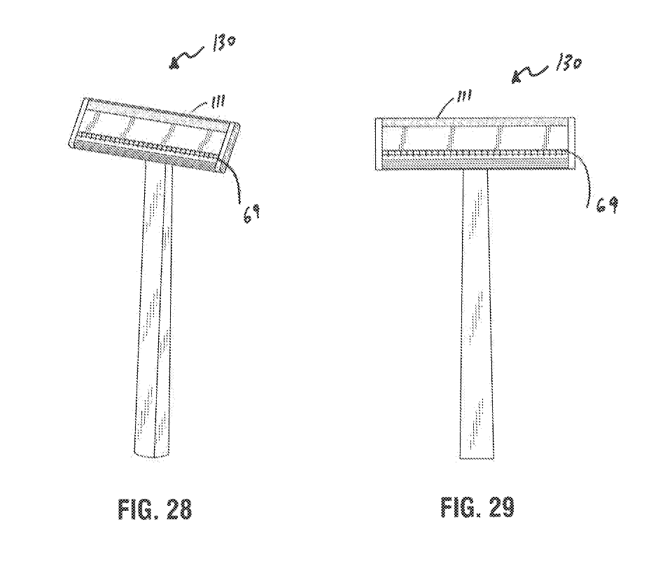

FIGS. 20-23 illustrate the razor 10 without a base stand 13 and are representations of a razor 10 with four mono-directionally disposed serrated-edge blades 63 in parallel to each other. FIGS. 24-25 illustrate three blades, FIGS. 26-27 illustrate 2 blades, and FIGS. 28-29 illustrate a single blade. Thus, FIGS. 16-29 merely depict the same razors of FIGS. 1-15 without the base stand 13.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

It should be noted that the language used in the specification has been principally selected for readability and instructional purposes, and may not have been selected to delineate or circumscribe the inventive subject matter. Accordingly, the disclosure is intended to be illustrative, but not limiting, of the scope of the present disclosure.

Having described the present disclosure above, various modifications of the techniques, procedures, materials and equipment will be apparent to those in the art. It is intended that all such variations within the scope and spirit of the appended claims be embraced thereby.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

What is claimed is:

1. A shaving razor head, comprising:
at least two lubricated strips extending across a length of the shaving razor head;
a serrated-edge blade positioned between the at least two lubricated strips; and
two side guards for holding the at least two lubricated strips and the serrated-edge blade in place.

2. The shaving razor head according to claim 1, wherein the serrated-edge blade employs a semi-circular concave down pattern.

3. The shaving razor head according to claim 1, wherein the serrated-edge blade includes two blades in parallel to each other and extending the length of the shaving razor head and wherein the serrated-edge blades face the same direction with each other.

4. The shaving razor head according to claim 1, wherein the serrated-edge blade includes three blades in parallel to each other and extending the length of the shaving razor head and wherein the serrated-edge blades face the same direction with each other.

5. The shaving razor head according to claim 1, wherein the serrated-edge blade includes four blades in parallel to each other and extending the length of the shaving razor head and wherein the serrated-edge blades face the same direction with each other.

6. The shaving razor head according to claim 1, wherein the serrated-edge blade includes two blades such that serrated edges of the first blade face serrated edges of the second blade in opposed relation to each other.

7. The shaving razor head according to claim 1, wherein the serrated-edge blade includes four blades such that serrated edges of two blades face serrated edges of the other two blades in opposed relation to each other.

8. A shaving razor, comprising:
a shaving razor head including:
at least two lubricated strips extending across a length of the shaving razor head;
a serrated-edge blade positioned between the at least two lubricated strips; and
two side guards for holding the at least two lubricated strips and the serrated-edge blade in place; and
a handle connected to the shaving razor head such that the shaving razor head with the serrated-edge blade moves in accordance with movement of the handle.

9. The shaving razor according to claim 8, wherein the serrated-edge blade employs a semi-circular concave down pattern.

10. The shaving razor according to claim 8, wherein the serrated-edge blade includes two blades in parallel to each other and extending the length of the shaving razor head and wherein the serrated-edge blades face the same direction with each other.

11. The shaving razor according to claim 8, wherein the serrated-edge blade includes three blades in parallel to each other and extending the length of the shaving razor head and wherein the serrated-edge blades face the same direction with each other.

12. The shaving razor according to claim 8, wherein the serrated-edge blade includes four blades in parallel to each other and extending the length of the shaving razor head and wherein the serrated-edge blades face the same direction with each other.

13. The shaving razor according to claim 8, wherein the serrated-edge blade includes two blades such that serrated edges of the first blade face serrated edges of the second blade in opposed relation to each other.

14. The shaving razor according to claim 8, wherein the serrated-edge blade includes four blades such that serrated edges of two blades face serrated edges of the other two blades in opposed relation to each other.

15. A shaving razor, comprising:
a shaving razor head including:
at least two lubricated strips extending across a length of the shaving razor head;
a serrated-edge blade positioned between the at least two lubricated strips; and
two side guards for holding the at least two lubricated strips and the serrated-edge blade in place;
a handle connected to the shaving razor head such that the shaving razor head with the serrated-edge blade moves in accordance with movement of the handle; and
a stand base for holding one end of the handle, such that the handle is substantially perpendicular to the stand base.

16. The shaving razor according to claim 15, wherein the serrated-edge blade employs a semi-circular concave down pattern.

17. The shaving razor according to claim 15, wherein the serrated-edge blade includes two blades in parallel to each other and extending the length of the shaving razor head and wherein the serrated-edge blades face the same direction with each other.

18. The shaving razor according to claim 15, wherein the serrated-edge blade includes three blades in parallel to each other and extending the length of the shaving razor head and wherein the serrated-edge blades face the same direction with each other.

19. The shaving razor according to claim 15, wherein the serrated-edge blade includes four blades in parallel to each other and extending the length of the shaving razor head and wherein the serrated-edge blades face the same direction with each other.

20. The shaving razor according to claim 15, wherein the serrated-edge blade includes four blades such that serrated edges of two blades face serrated edges of the other two blades in opposed relation to each other.
